(19) United States
(12) Patent Application Publication
(10) Pub. No.: US 2009/0205577 A1
(43) Pub. Date: Aug. 20, 2009

(54) AROMA THERAPEUTIC PET LITTER AND METHOD OF MAKING SAME

(76) Inventor: John F. Kimmel, Mississauga (CA)

Correspondence Address: MILLER THOMPSON, LLP, Scotia Plaza, 40 King Street West, Suite 5800, TORONTO, ON, M5H 3S1, CA

(21) Appl. No.: 12/030,152

(22) Filed: Feb. 12, 2008

(51) Int. Cl. A01K 29/00; B01J 20/22

(52) U.S. Cl. 119/171; 502/401

(57) ABSTRACT

The present invention discloses a method, product and method of manufacture for the product, all providing an aroma therapeutic pet litter. The aroma therapeutic pet litter is useful to provide therapeutic effects to pets. This, in turn, is beneficial in that a pet is encouraged to use the litter box for depositing animal waste.

### FIELD OF THE INVENTION

The present invention discloses a pet litter product with aromatic properties. More specifically, the present invention discloses a pet litter product that provides odour control of pet waste matter and provides a therapeutic effect to pets. The present invention also discloses a method for manufacture of the aromatherapy pet litter product.

### BACKGROUND

Products for odour control of animal waste have existed for many years. These products are generally referred to as pet litter or animal litter (hereafter the term “pet litter” will be used). Most pet litter products are aimed at absorption of moisture from animal waste, which in turn reduces foul odour emanating from ammonia and other components of animal waste.

There are presently many types of pet litter, made from different products. These include sand, clay, bentonite (which is used in clumping litter), silica gel, and biodegradable products such as pine pellets, sawdust, and corn cobs. There are various advantages and disadvantages of each type relative to the others with respect to characteristics such as absorbency, degree of odour control, environmental friendliness, longevity, cost, safety, and texture.

However, none of these products targets an animal's comfort or benefit or to encourage the animal to use the litter box. Generally, animal waste odour control products are intended to benefit human owners of pets by enabling the owner to avoid exposure to foul smells of animal waste. It is therefore generally required to add products to pet litter in order to provide a benefit to a pet, or to encourage litter box useage.

One benefit to animals that may be provided in pet litter is a method or product of providing a positive physiological response in an animal. This may be through aromatherapy, for example.

U.S. Pat. No. 6,253,710 to Ward et al. discloses an odour control for animal litter product. The product is applied to existing pet litter or animal container or animal waste. Furthermore, the product comprises a mixture of chemicals such as lauryl methacrylate, acetone, and 2-hydroxy-2′,4,4′-trichlorophenyl ether. Ward et al describe the optional addition of fragrance to the composition. However, there is no description of any positive effect for an animal, or to encourage litter box useage.

U.S. Pat. No. 6,371,049 to Boren et al. discloses an animal litter. The animal litter is used to inhibit odor using western juniper. Boren et al. contemplates a second fragrance being added to the composition, including essential oils. However, there is no description of a method of encouraging a pet to use the animal litter.

U.S. Pat. No. 6,803,033 to McGee et al. discloses a process for maintaining fragrance perception in the presence of an absorbent material. The process includes providing a delivery vehicle containing an enrobement material, a fragrance, and a fixative, which are then combined with a moisture and/or malodour absorber to convey a fragrance to the atmosphere, and to provide an absorbent for moisture and/or malodors, including with respect to pet litter. However, there is no description of a method of encouraging a pet to use pet litter.

U.S. Pat. No. 6,936,344 to Represas de Almeida et al. discloses an absorbent composition of matter for odoriferous substances and releaser of diverse active ingredients. The product is made available as a woody ring of corn cobs which is placed in pet litter. Represas de Almeida et al describe that natural or synthetic elements may be added to a carrier compound to achieve a perfuming, liberating, therapeutic, repellent or attractant effect. However, there is no description of any positive effect for an animal.

U.S. Pat. No. 7,247,377 to Jassan et al. relates to an absorbent composition of matter for controlled release of essential oils. The composition may comprise an essential oil which may be of an attractant odour. However, the composition disclosed would have to be added to a pet litter product manually to product a pet litter product encouraging litter box useage.

Moreover U.S. Pat. No. 6,173,675 teaches aromatherapy mats for pets which include mixtures of lavender flower.

There also exist products commonly referred to as training litters, that encourage an animal to use a litter box, typically by incorporating a herbal blend additive to draw an animal to a litter box. However, these products do not promote any other advantage, such as additionally deodorizing the surround air of a litter box in addition to the natural function of the litter.

However, what is not described in the prior art are pet litter products that provide a positive effect for an animal such that the animal is encouraged to use the pet litter. Furthermore, what is not described in the prior art is a method of making commercially available such an additive already combined with the pet litter.

Therefore what is required is a pet litter product providing positive effects for animals. What is also required is such a pet litter product being made commercially available without a need for a consumer to combine the effective element with the litter element.

### SUMMARY OF THE INVENTION

One aspect of this invention relates to an aromatherapy pet litter comprising: a pet litter; and an aroma therapeutic fragrance combination applied to the pet litter at a weight percentage less than 20. In one embodiment the weight percentage of therapeutic fragrance is less applied between 0.1 and 2% and preferably 0.07%.

Another aspect of this invention relates to a method for providing aroma therapy for pets comprising providing an aroma therapeutic fragrance combination mixed with pet litter, wherein said aroma therapeutic fragrance combination is applied to the pet litter at a weight percentage less than 20 and wherein said aroma therapeutic fragrance combination provides a therapeutic effect to a pet.

Yet another aspect of this invention relates to a method for manufacturing an aromatherapy pet litter comprising combining a fragrance; an essential oil; a surfactant; and a pet litter such that the combination of the fragrance, essential oil, and surfactant is applied to the pet litter at a weight percentage less than 20. In a further embodiment the fragrance is applied between 0.01% and 2% and preferably 0.07%.

### DETAILED DESCRIPTION OF THE INVENTION

The present invention discloses a pet litter and pet litter supplement that provides odour control of animal waste matter. The present invention also discloses a pet litter and pet litter supplement that provides a therapeutic effect to pets, or encouragement for litter box useage. The present invention further discloses a method for the manufacture of pet litter incorporating a pet litter additive providing odour control and therapeutic effects, or encouragement for litter box useage

The pet litter of the present invention may be comprised of a combination of a substrate such as clay and an aroma therapeutic fragrance combination applied to the clay.

The clay may preferably be provided as 100% natural clay. The clay may optionally be provided as a combination of natural clay and other materials so long as the combined product may receive the hydrosol compound described below. The clay may also be provided without any natural clay so long as the product may receive the hydrosol compound described below and is substantially absorbent and solidifying in line with the purpose of pet litter. For example, the non-clay component of the pet litter may comprise any of a bentonite, silica gel, pine , paper, mixture of biodegradable products, or any other generally available pet litter composition.

The aroma therapeutic fragrance combination may be provided in various forms. Preferably, the aroma therapeutic fragrance combination comprises an aromatic compound combined with an aromatic essential oil and a surfactant. The aromatic compound may be a hydrosol, for example. The aromatic compound may be provided in liquid form, solid form, or powder form.

The aromatic compound provides the primary means of odour control of pet waste matter. The aromatic essential oil provides the pet litter with a longer lasting fragrance than would the aromatic compound alone. The odour of the aromatic essential oil is preferably matched to the odour of the aromatic compound. For example, the preferred embodiment of the present invention comprises a lavender fragrance as the aromatic compound and a lavender essential oil. The lavender essential oil provides a longer lasting lavender scent to the pet litter than would the lavender hydrosol alone.

The surfactant may be any surfactant that lowers the surface tension of the aromatic compound. The surfactant is added to the aromatic compound both to dissolve the aromatic compound into the essential oil and to promote spreading of the aromatic compound in the pet litter. Preferably, the surfactant used is non-ionic primary alcohol alkoxylate which is operable to promote spreading of a lavender hydrosol and lavender oil combination in the pet litter.

The aroma therapeutic fragrance combination may be applied to the pet litter at a weight percentage of less than 20%. More specifically, a weight percentage between 0.01% and 2% provides optimal results. Preferably, a weight percentage of 0.07% is used.

As previously mentioned, the pet litter to which the aroma therapeutic fragrance combination is applied may be any generally available pet litter to which the aroma therapeutic fragrance combination may be spread.

The aromatic pet litter disclosed by the present invention has three main purposes. Firstly, the aromatic nature of the pet litter is beneficial to overcome the generally foul odour of pet urine and feces deposited by a pet in the pet litter. Secondly, the aroma therapeutic fragrance combination is preferably selected to provide a therapeutic effect to a pet. The preferred embodiment using lavender fragrance and lavender essential oil provides a calming and serenity-inducing sensation to the pet as lavender is generally accepted to promote a sense of calm and serenity. Thirdly, the therapeutic effect is attractive to a pet and encourages use of the pet litter by the pet.

In addition the combination creates an all natural cat litter with botanical lavender aromatherapy The lavender aromatherapy cat litter is non toxic, creates minimal dust, and upon contact with liquid, the cat litter encapsulates the animal waste in order to facilitate disposal.

The manufacture of the aromatic pet litter may be accomplished through several means depending on the nature of the aromatic compound.

In one embodiment lavender fragrance T-7000 which contains lavender hydrosol, lavender oil and surfactant (to combine the two ingredients) have been effectively used.

The aromatic compound may be provided in liquid form. In this case, the aromatic compound is mixed with the aromatic essential oil and surfactant. Any generally known method of mixing these components may be used. The resulting aroma therapeutic fragrance combination may then be applied to the pet litter using a spray.

Alternatively the aromatic compound may first be applied to the pet litter using a spray, and then the aromatic essential oil is applied by spray. Finally, the surfactant may be applied by spray.

The aromatic compound may also be provided in a solid or powder form. In this case, the aromatic compound may be added to the pet litter using a conveyor auger system. The conveyor auger system evenly mixes the aromatic compound with the pet litter. Following mixing, the aromatic essential oil and surfactant may be added to the pet litter.

Optionally, the aromatic compound may be mixed with an aqueous solvent, which may also be mixed with the aromatic essential oil and surfactant. This compound may then be applied to the pet litter using a spray.

Storage of the hydrosol combination may be accomplished by sealing it in an impermeable container. Preferably, a sealed, impermeable, high density polyethylene (HDPE) container is used. However other containers can be used.

We claim:

1. An aromatherapy pet litter comprising:
(a) a pet litter; and
(b) an aroma therapeutic fragrance combination applied to the pet litter at a weight percentage less than 20.

2. The aromatic pet litter as claimed in claim 1 wherein the aromatherapy pet litter masks the odour of pet waste.

3. The aromatic pet litter as claimed in claim 1 wherein the aromatherapy pet litter provides a therapeutic effect to a pet.

4. The aromatic pet litter as claimed in claim 3 wherein the aroma therapeutic fragrance combination includes lavender fragrance and the therapeutic effect is a sense of calm and serenity.

5. The aromatic pet litter as claimed in claim 1 wherein the aroma therapeutic fragrance combination includes an aromatic compound, an essential oil, and a surfactant.

6. The aromatic pet litter as claimed in claim 5 wherein a scent of the aromatic compound and a scent of the essential oil are matched.

7. The aromatic pet litter as claimed in claim 1 wherein the weight percentage is less than 10.

8. The aromatic pet litter as claimed in claim 7 wherein the weight percentage is between 0.01 and 2.

9. The aromatic pet litter as claimed in claim 8 wherein the weight percentage is 0.07.

10. A method for providing aroma therapy for pets comprising providing an aroma therapeutic fragrance combination mixed with pet litter, wherein said aroma therapeutic fragrance combination is applied to the pet litter at a weight percentage less than 20 and wherein said aroma therapeutic fragrance combination provides a therapeutic effect to a pet.

11. The method of claim 10 wherein the aroma therapeutic fragrance combination includes lavender fragrance and the therapeutic effect is a sense of calm and serenity.

12. The method of claim 10 wherein the aroma therapeutic fragrance combination includes an aromatic compound, an essential oil, and a surfactant.

13. The method of claim 12 wherein a scent of the aromatic compound and a scent of the essential oil are matched.

14. The method of claim 10 wherein the weight percentage is less than 10.

15. The method of claim 14 wherein the weight percentage is between 0.01 and 2.

16. The method of claim 15 wherein the weight percentage is 0.07.

17. A method for manufacturing an aromatherapy pet litter comprising combining a fragrance; an essential oil; a surfactant; and a pet litter such that the combination of the fragrance, essential oil, and surfactant is applied to the pet litter at a weight percentage less than 20.

18. The method of claim 17 wherein the fragrance is provided as a solid or powder and the fragrance is combined with the pet litter using a conveyor auger system.

19. The method of claim 17 wherein the fragrance is provided as a liquid and the fragrance is combined with the pet litter using a spray system.

20. The method of claim 17 wherein the weight percentage is between 0.01 and 2.
